(19) United States
(12) Patent Application Publication
(10) Pub. No.: US 2026/0253567 A1
(43) Pub. Date: Aug. 27, 2026

(54) MUSICAL NOTATION AND METHODS OF VISUALLY REPRESENTING MUSIC

(71) Applicant: Payam Music, Seattle, WA (US)

(72) Inventor: Payam KHASTKHODAEI, Seattle, WA (US)

(73) Assignee: Payam Music, Seattle, WA (US)

(21) Appl. No.: 19/060,460

(22) Filed: Feb. 21, 2025

(51) Int. Cl. G10G 1/02

(52) U.S. Cl. CPC G10G 1/02

(57) ABSTRACT

A musical notation for piano including a plurality of fields, wherein each field of the plurality of fields represents a measure of music, and where each field includes a plurality of columns, wherein a number of columns in the plurality of columns is equal to a number of beats per measure, a plurality of rows, wherein a number of rows in the plurality of rows is at least equal to a number of distinct pitches in a plurality of right-hand notes, and a base note indicator comprising a base note of a plurality of left-hand notes, and the musical notation further includes a left-hand pattern comprising a series of numbers.

### BACKGROUND

Conventional musical notation such as sheet music may be used to teach an individual how to play piano, but it is often very challenging for beginner players to understand. In order to teach someone to play the piano, a variety of additional techniques are used. For example, pitches of each note may be listed above or inside each note in the music. Additionally, numbers representing fingers of the player or beats on which the note is to be played on may be written onto the sheet music. Physical tools may also need to be used, such as marking the piano physically with tape or stickers, including pitches or fingerings visually on the instrument. Further, workbooks or additional materials may also be needed to help individuals learn how to play piano. This can result in frustration for a player, confusion, and an inability to read sheet music or otherwise play the piano. It can also result in damage to the instrument or the musical notation.

Accordingly, musical notation and methods for providing musical notation that is intuitive for beginners and easy to teach from are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Disclosed herein is a musical notation for piano, including a plurality of fields, wherein each field of the plurality of fields represents a measure of music, and where each field includes a plurality of columns, wherein a number of columns in the plurality of columns is equal to a number of beats per measure, a plurality of rows, where a number of rows in the plurality of rows is greater than or equivalent to a number of distinct pitches in a plurality of right-hand notes, and a base note indicator comprising a base note of a plurality of left-hand notes, and a left-hand pattern comprising a series of numbers.

In some embodiments, each field further includes a plurality of right-hand notes, where each right-hand note includes a number corresponding to a beat the right-hand note is to be played on, and a letter corresponding to a pitch of the right-hand note. In some embodiments, each distinct pitch of the distinct pitches in the plurality of right-hand notes is assigned to a row of the plurality of rows. In some embodiments, the beat the right-hand note is to be played on determines which column of the plurality of columns the right-hand note is located, and wherein the pitch of the right-hand note determines which row of the plurality of rows the right-hand note is located.

In some embodiments, each number of the series of numbers corresponds to a scale degree of each left hand-note of the plurality of left-hand notes, relative to the base note, or each number of the series of numbers corresponds to a finger of a left-hand of a player.

In some embodiments, the base note indicator includes a color based on a pitch of the base note.

In some embodiments, the number of rows of the plurality of rows is four more than the number of distinct pitches in the plurality of right-hand notes. In some embodiments, a highest distinct pitch is assigned to a second row of the plurality of rows, and wherein a lowest distinct pitch is assigned to a fourth row from a bottom row of the plurality of rows.

In some embodiments, the musical notation further comprises a listing of the distinct pitches in the plurality of right-hand notes.

In some embodiments, a value of each number of the series of numbers of the left-hand pattern determines a vertical placement of the number on the musical notation. In some embodiments, the left-hand pattern is located at a top of the musical notation. In some embodiments, the base note indicator is circular.

In another aspect, disclosed herein is a method for visually representing music to be played on a piano, including determining a number of beats per measure of the music, providing a plurality of fields, wherein each field of the plurality of fields represents a measure of music, splitting each field of the plurality of fields into a plurality of columns, wherein a number of columns of the plurality of columns is equal to the number of beats per measure, determining a number of distinct pitches in a plurality of right-hand notes, splitting each field of the plurality of fields into a plurality of rows, wherein a number of rows of the plurality of rows is at least equal to a number of the distinct pitches in the plurality of right-hand notes, arranging each right-hand note of the plurality of right-hand notes into a column of the plurality of columns, and a row of the plurality of rows based on a beat on which the right-hand note is to be played and a pitch of the right-hand note, respectively, indicating a base note of a plurality of left-hand notes in each field of the plurality of fields, determining a left-hand pattern comprising a series of numbers, and providing the left-hand pattern on the musical notation.

In some embodiments, each number of the series of numbers corresponds to a scale degree of each left hand-note of the plurality of left-hand notes, relative to the base note, or each number of the series of numbers corresponds to a finger of a left-hand of a player.

In some embodiments, each right-hand note includes a number corresponding to the beat the right-hand note is to be played on, and a letter corresponding to the pitch of the right-hand note.

In some embodiments, the number of rows of the plurality of rows is four more than the number of distinct pitches in the plurality of right-hand notes.

In some embodiments, the method further includes assigning a highest distinct pitch to a second row of the plurality of rows; and assigning a lowest distinct pitch to a fourth row from a bottom row of the plurality of rows.

In some embodiments, the method further includes coloring each base note indicator based on a pitch of the base note. In some embodiments, providing the left-hand pattern includes determining a vertical placement of each number of the series of numbers based on a value of each number of the series of numbers.

In some embodiments, providing the left-hand pattern includes determining a horizontal placement of each number of the series of numbers based on a beat that each left-hand note of the plurality of left-hand notes is to be played on.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an example conventional musical notation;

FIG. 2 is an example musical notation, in accordance with the present technology;

FIGS. 3A-3F are process steps of preparing an example musical notation, in accordance with the present technology;

FIGS. 4A-4G are process steps of preparing example musical notation based on the conventional musical notation of FIG. 1, in accordance with the present technology;

FIG. 5A is an example conventional musical notation having four beats per measure;

FIG. 5B is an example musical notation based on the conventional musical notation of FIG. 5A in accordance with the present technology;

FIG. 6A is an example conventional musical notation having six beats per measure;

FIG. 6B is an example musical notation based on the conventional musical notation of FIG. 6A in accordance with the present technology;

FIG. 7A is an example conventional musical notation having eight beats per measure;

FIG. 7B is an example musical notation based on the conventional musical notation of FIG. 7A in accordance with the present technology;

FIG. 8 is an example method for visually representing music to be played on a piano, in accordance with the present technology;

FIG. 9 is another example method for visually representing music to be played on a piano, in accordance with the present technology; and

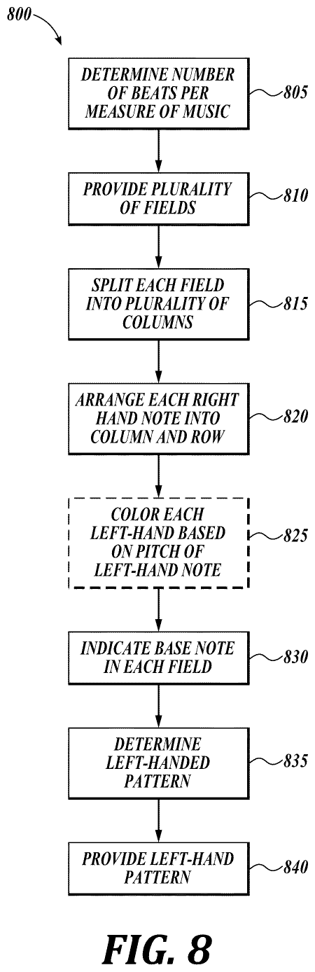

FIG. 8 is yet another example method for visually representing music to be played on a piano, in accordance with the present technology.

### DETAILED DESCRIPTION

Disclosed herein is a musical notation and a method for representing the musical notation that is configured to aid in teaching individuals, such as children, how to play the piano. The musical notation disclosed herein includes visual representations of each measure of music, a pitch and beat for each note to be played by a right hand of a player (i.e., “a plurality of right-hand notes”), a base note for each measure based on the notes to be played by a left hand of a player, and a left-hand pattern. By arranging music in the novel way described and illustrated herein, musical notation may be simplified in a way that allows for the player to more easily learn a piece of music.

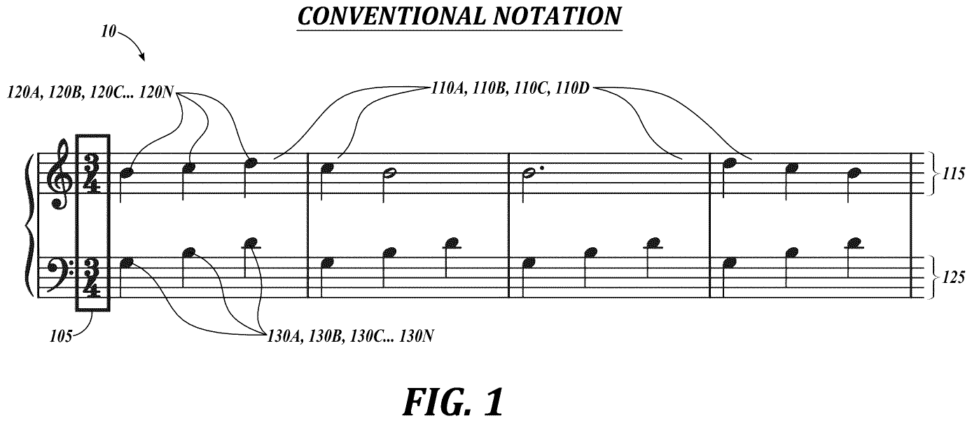

FIG. 1 is an example conventional musical notation 10. Briefly, conventional musical notation 10 includes a time signature 105, one or more measures 110A, 110B, 110C, 110D, a plurality of right-hand notes 115, and a plurality of left-hand notes 125. The plurality of right-hand notes 115 includes one or more right hand notes 120A, 120B, 120C . . . 120N. Similarly, the plurality of left-hand notes 120 includes one or more left hand notes 130A, 130B, 130C . . . 130N. For clarity, not all right-hand notes 120 and/or left-hand notes 130 are labeled in FIG. 1. One skilled in the art will recognize that conventional musical notation for piano (as shown in FIG. 1) further includes a treble clef staff (top staff) and a bass clef staff (bottom staff). Each line of each staff represents a pitch that a note is to be played. From the bottom of the treble clef staff, the pitches illustrated by the lines are EGBDF and the spaces represent the pitches FACE. From the bottom of the bass clef staff, the pitches illustrated by the lines are GBDFA and the spaces represent the pitches ACEG. One skilled in the art will understand how conventional musical notation 10 is read and understood, and thus not all elements of conventional musical notation 10 include a numeral. For example, note heads, flags, and stems are not enumerated in FIG. 1, as one skilled in the art will recognize that these elements determine a pitch, beat, and duration of each note on both the treble clef staff and the bass clef staff. Conventional musical notation 10 thus visually represents music, in this case, for the piano.

Conventional musical notation 10 may be used to teach an individual how to play piano, but often, a variety of additional techniques must be used to teach a beginner player how to understand, read, and play conventional musical notation 10. For example, pitches of each note may be listed above or inside each note of the plurality of right-hand notes 115 and/or the plurality of left-hand notes 125 (not shown in FIG. 1). Further, workbooks or additional materials may also be needed to help individuals learn how to play piano.

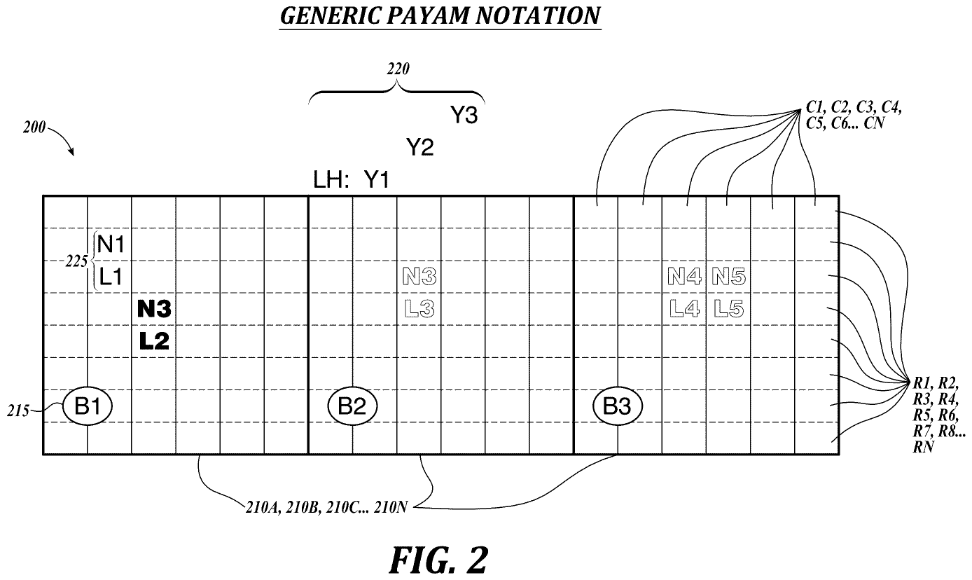

FIG. 2 is an example musical notation 200, in accordance with the present technology. Musical notation 200 includes a plurality of fields 210A, 210B, 210C . . . 210N, a plurality of right-hand notes including at least one right-hand note 225, and a left-hand pattern 220. Musical notation 200 is “generic,” that is, it does not visually represent a particular piece of music but rather illustrates a variety of optional elements that may be included when visually representing a piece of music in the disclosed musical notation 200.

In some embodiments, each field of the plurality of fields 210A, 210B, 210C . . . 210N represents a measure of music (i.e., corresponds to measures 110A, 110B, 110C . . . 110N of FIG. 1). For example, three fields are illustrated in FIG. 2. Accordingly, musical notation 200 has three measures. While three fields are illustrated, it should be understood that any number of fields (and thus, measures) may be illustrated, such as 1, 10, 100, 1000, 10,000, or the like.

In some embodiments, each field of the plurality of fields 210A, 210B, 210C . . . 210N, includes a plurality of columns C1, C2, C3, C4, C5, C6 . . . CN. In some embodiments, each column of the plurality of columns C1, C2, C3, C4, C5, C6 . . . CN represents a number of beats per measure of music. For example, six columns are shown in musical notation 200. Accordingly, musical notation 200 has six beats per measure. While six columns are illustrated, it should be understood that any number of columns (and thus, beats per measure) may be illustrated, such as 2, 4, 6, 8, 16, or the like.

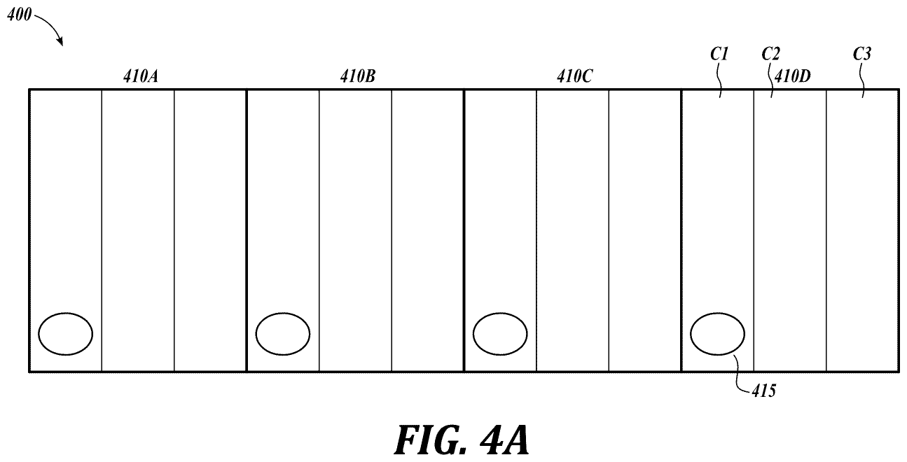

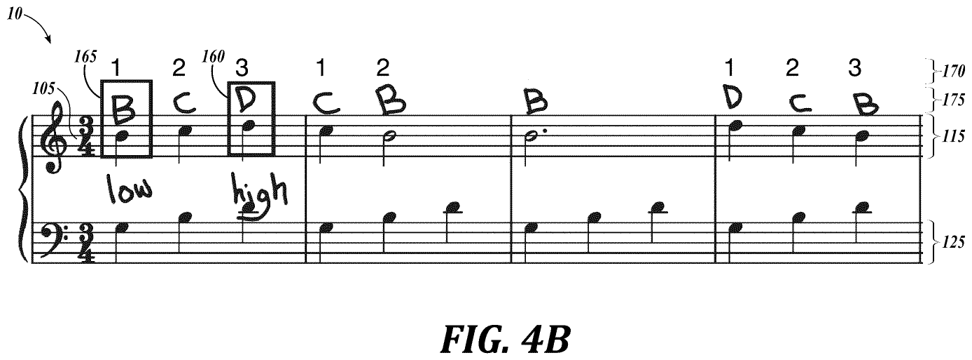

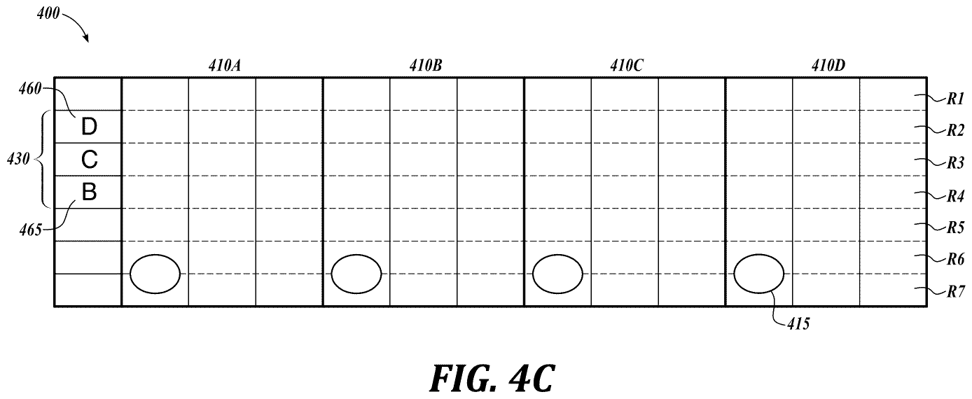

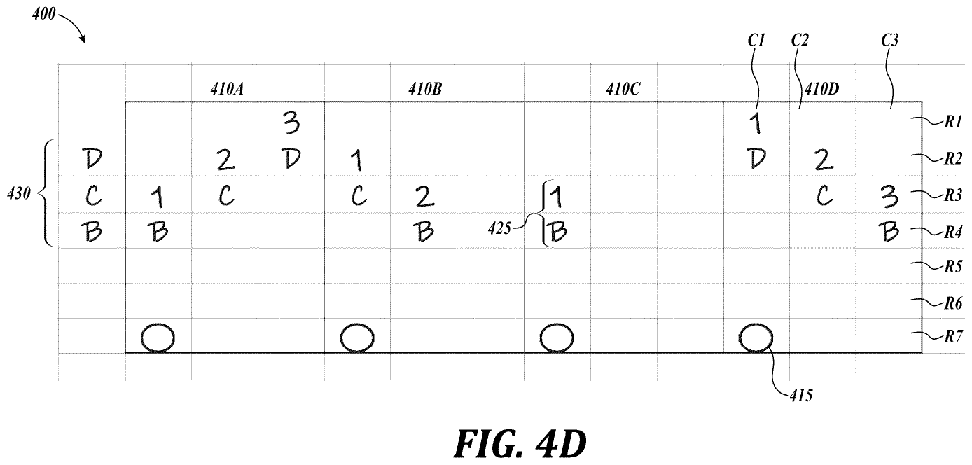

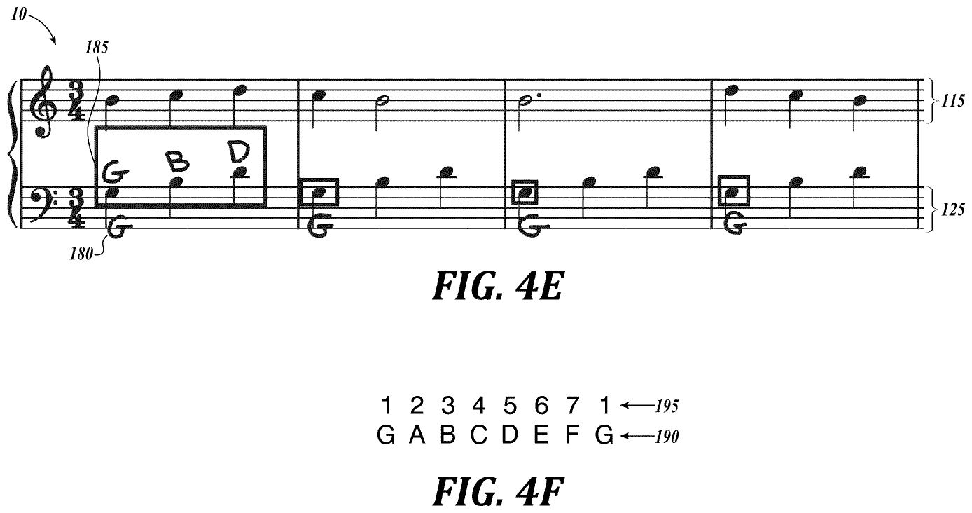

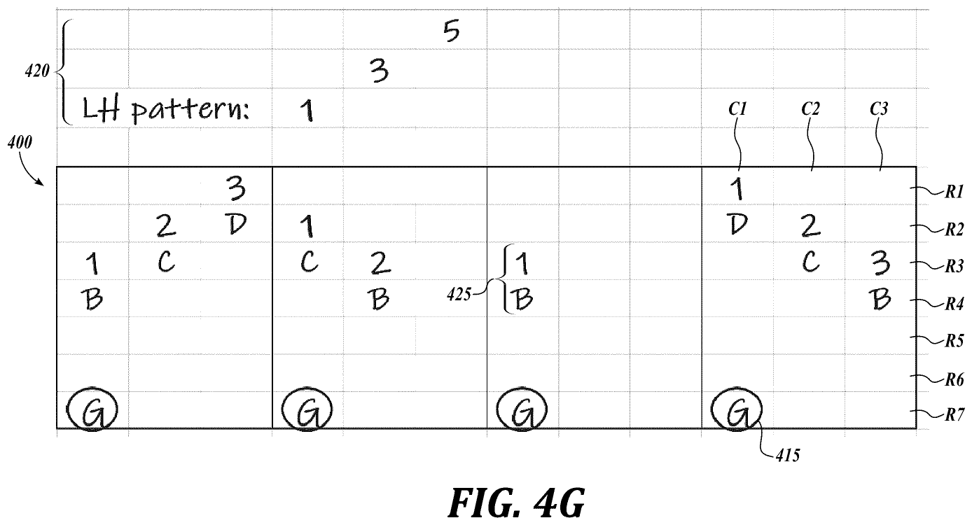

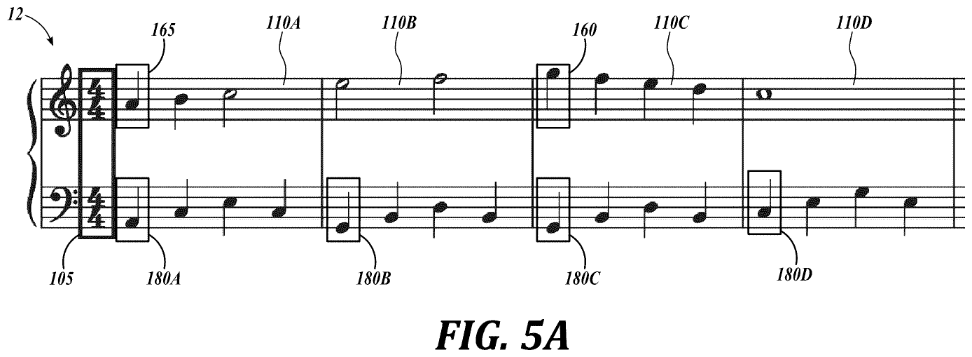

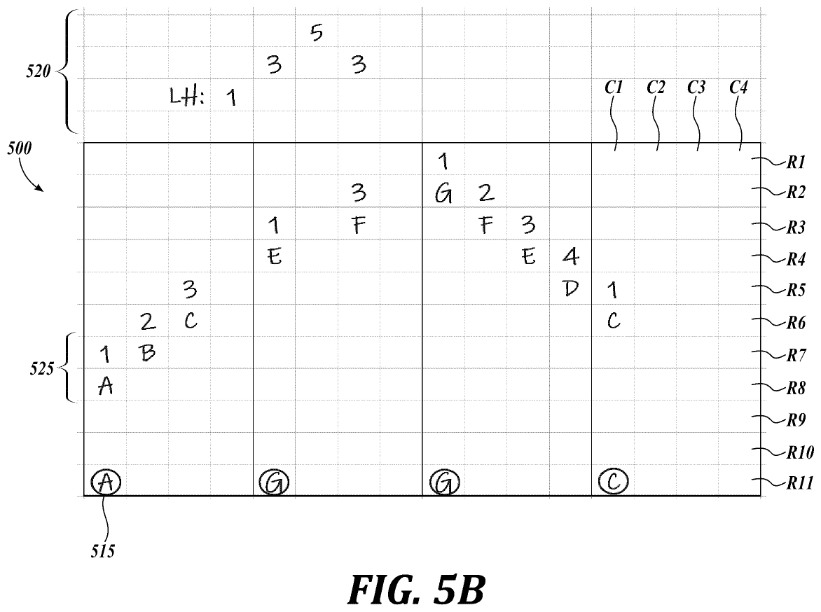

In some embodiments, each field of the plurality of fields 210A, 210B, 210C . . . 210N may also include a base note indicator 215. In some embodiments, each base note indicator 215 represents a base note B1, B2, B3 of a plurality of left-hand notes for each measure, as explained in detail in FIGS. 4E-4G. Base notes B1, B2, B3 are pitches of the base note for each measure of music. Base notes B1, B2, B3 may be the same pitch (such as shown in FIG. 4G) or different pitches (such as shown in FIGS. 5B, 6B, and 7B) depending on the piece of music the musical notation 200 represents. In some embodiments, the base note indicator 215 is circular. In some embodiments, the base note indicator is located in a bottom left corner of each field of the plurality of fields 210A, 210B, 210C . . . 210N. In some embodiments, the base note indicator includes a color based on a pitch of the base note. For example, in FIG. 2, as the pitch of the base note for each field is the same, each base note indicator may be a same color as shown in FIG. 2.

In some embodiments, the musical notation 200 includes a plurality of right-hand notes including at least one right-hand note 225. Only one right-hand note 225 is labeled for clarity; FIG. 2 shows five right-hand notes in total. In some embodiments, each right-hand note 225 includes a number N1 and a letter L1. Accordingly, the right-hand notes illustrated in musical notation 200 are N1, L1; N2, L2; N3, L3; N4, L4; and N5, L5 (collectively “the plurality of right-hand notes”).

In some embodiments, each number N1, N2, N3, N4, N5 of the plurality of right-hand notes represents a beat on the respective right-hand note is to be played. In FIG. 2, each field in the plurality of fields 210A, 210B, 210C . . . 210N has six columns, representing six beats per measure. In some embodiments, a location of the numbers N1, N2, N3, N4, N5 is determined by a column of the plurality of columns C1, C2, C3, C4, C5, C6 . . . CN associated with each beat of the beats per measure. Accordingly, right-hand note 225 is shown in column 2 (C2) of first field 210A. Thus, right-hand note 225 is to be played on beat two, and thus N1 would be “2”. Similarly, N2 would be “3,” N3 would be “3,” N4 would be “3,” and N5 would be “4.”

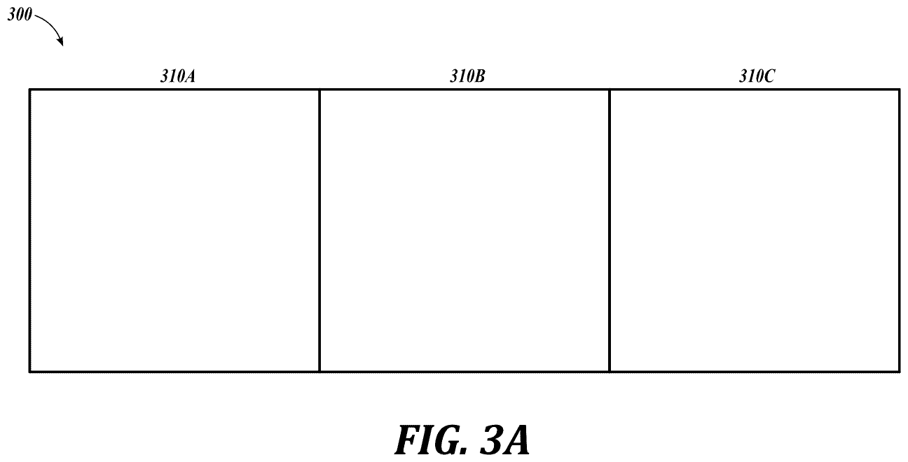

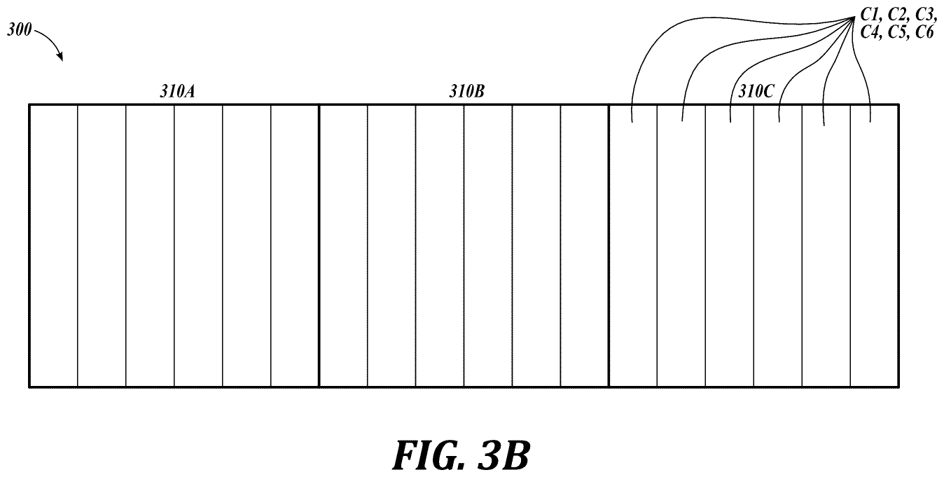

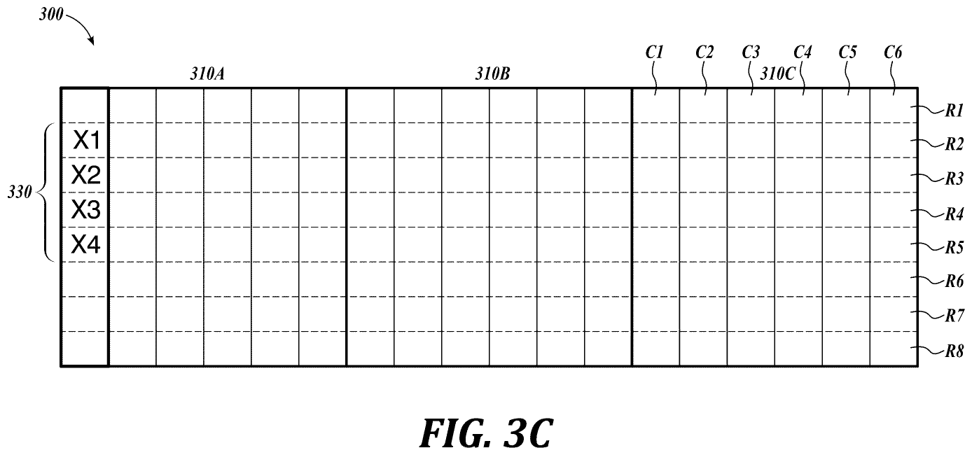

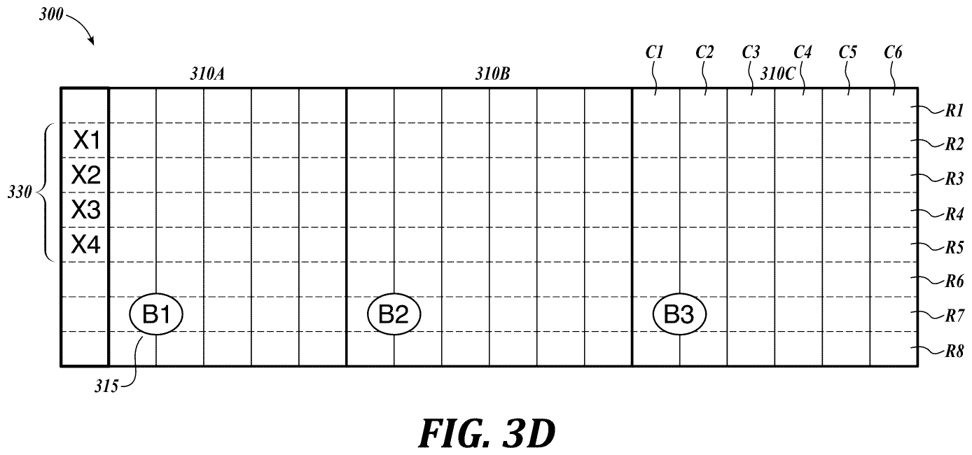

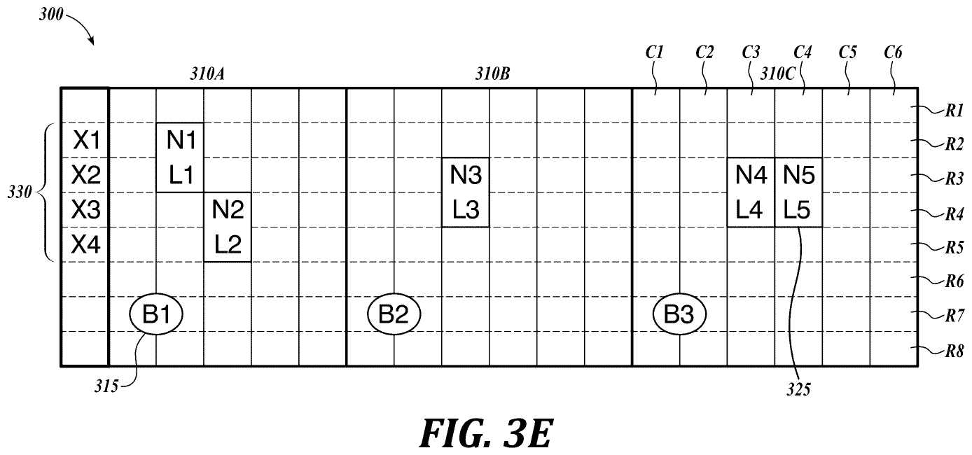

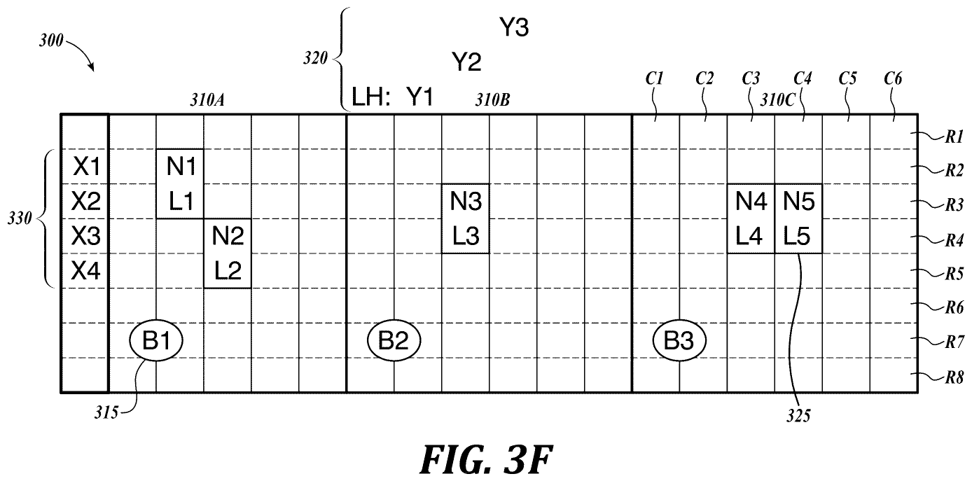

In some embodiments, each field of the plurality of fields 210A, 210B, 210C . . . 210N may also include a plurality of rows R1, R2, R3, R4, R5, R6, R7, R8 . . . RN. In some embodiments, a number of rows in the plurality of rows is greater than or equivalent to a number of distinct pitches in a plurality of right-hand notes. In some embodiments, each field includes at least as many rows as distinct pitches in the plurality of right-hand notes. For example, if the plurality of right-hand notes includes three distinct pitches, there may be three rows. In other embodiments, the number of rows R1, R2, R3, R4, R5, R6, R7, R8 . . . RN is four more than a number of distinct pitches in the plurality of right-hand notes, as shown and explained in FIG. 3F. In FIG. 2, there are eight rows. In some embodiments, when there are four more rows than the number of distinct pitches (as shown in FIG. 2), a highest distinct pitch is assigned to a second row of the plurality of rows, and a lowest distinct pitch is assigned to a fourth row from a bottom row of the plurality of rows. For example, if the plurality of right-hand notes has four distinct pitches, the lowest distinct pitch would be assigned to row five (R5) and the highest distinct pitch would be assigned to row two (R2) of the eight total rows.

In some embodiments, each letter L1, L2, L3, L4, L5 of the plurality right-hand notes N1, L1; N2, L2; N3, L3; N4, L4; and N5, L5 represents a pitch of each respective right-hand note. As explained and shown herein, a location of each letter L1, L2, L3, L4, L5 may be determined by a row of the plurality of rows R1, R2, R3, R4, R5, R6, R7, R8 . . . RN associated with each distinct pitch of the plurality of right-hand notes. Accordingly, if one right-hand note has a same pitch as another right-hand note, both right-hand notes will appear in the same row of the plurality of rows R1, R2, R3, R4, R5, R6, R7, R8 . . . RN. For example, in FIG. 2, the right-hand note N3, L3 has a same pitch as the right-hand note N4, L4 and the right-hand note N5, L5 because they are all located in the same row (R3). In this example, L3, L4, and L5 would be the same letter representing the pitch (e.g., A, B, C, D, E, F, or G). In some embodiments, the letter representing the pitch may also be designated sharp (#) or flat (♭) depending on the pitch. For example, if the pitch of L3, L4, and L5 was G, then L3, L4, and L5 would be “G.” As another example, if the pitch of L3, L4, and L5 was A flat, L3, L4, and L5 would be “A♭.”

Further, right-hand notes with a pitch one step lower than N4, L4 (such as N2, L2) are represented in a lower row (such as R4), and right-hand notes with a pitch one step higher than N4, L4 (such as N1, L1) are represented in a higher column (such as R2). It should be understood that “steps” of each pitch are determined based on the number of distinct pitches of the plurality of right-hand notes. For example, if the right-hand notes included the distinct pitches of D, F, and G, “D” would be considered the lowest pitch of the right-hand notes, and “G” would be considered the highest pitch of the right-hand notes. Further, “F” would be considered “a step” above D, as the pitch E is not present in the right-hand notes. Similarly, G would be considered “a step” above F. Accordingly, right-hand notes having the pitch “G” would be in a highest row (such as R2), right-hand notes having the pitch “F” would be in the next highest row (such as R3), and right-hand notes having the pitch “D” would be in the lowest row (such as R4). In some embodiments, each right-hand note of the plurality of right hand-notes further includes a color corresponding to the pitch of the right-hand note. As shown in FIG. 2, right-hand notes having a same pitch are a same color (N3, L3; N4, L4; and N5, L5 are all white with a black outline). While FIG. 2 is shown in black and white, it should be understood that each right-hand note of the plurality of right-hand notes may be any color, such as red, orange, yellow, blue, green, indigo, violet, pink, and the like. In some embodiments, each note of the plurality of notes may further include another visual indicator corresponding to the pitch of the respective right-hand note, such as bolding, underlining, circling, bordering, or the like, in either black and white or color.

In this manner, each right-hand note of the plurality of right-hand notes visually conveys both a pitch of the respective right-hand note and the beat which the respective right-hand note is to be played.

In some embodiments, the musical notation 200 further includes a left-hand pattern (“LH”) 220. It is standard for pieces of piano music, and especially music for beginner piano players, to have the left hand of a player playing a repeating series of left-hand notes. Accordingly, in some embodiments, this left-hand pattern can be identified and represented as LH 220. The LH 220 may include a series of numbers Y1, Y2, Y3. Each number in the series of numbers Y1, Y2, Y3 may correspond to a scale degree of each left-hand note of a plurality of left-hand notes, relative to the base note, as shown and described in detail in FIGS. 4E-4G. As used herein, a “scale degree” is a number of notes higher (or lower than) a base note of the plurality of left-hand notes (as shown in FIG. 4F). For example, the base note would have a scale degree (and thus a number of the series of numbers Y1, Y2, Y3) of “1,” a note having a pitch one step higher than the base note would have a scale degree (and thus a number of the series of numbers Y1, Y2, Y3) of “2,” and so on.

In some embodiments, each number of the series of numbers corresponds to a finger on a left-hand of a player. For example, the number “1” corresponds to a thumb, the number “3” corresponds to a middle finger, the number “5” corresponds to a pinky, and so on. In this manner, the LH 220 may instead instruct a player on which finger of their left-hand to use to play the left-hand note.

In some embodiments, a value of each number of the series of numbers Y1, Y2, Y3 of the LH 220 determines a vertical placement of the number (such as Y1, Y2, Y3) on the musical notation 200. For example, in FIG. 2, Y1 has a lowest scale degree (e.g., “1”), Y2 has a higher scale degree (e.g., “3”), and Y3 has a highest scale degree (e.g., “5”). Accordingly, Y1 is shown having a lowest vertical placement, Y2 has a higher vertical placement, and Y3 has a highest vertical placement in FIG. 2. In some embodiments, a beat that each left-hand note of the plurality of left-hand notes is to be played on determines a horizontal placement of the number (such as Y1, Y2, Y3) on the musical notation 200. For example, when the LH 220 is centered over a field of the plurality of fields (such as field 210B in FIG. 2), the horizontal placement of each number of the series of numbers Y1, Y2, Y3 lines up with the respective column of the plurality of columns C1, C2, C3, C4, C5, C6 . . . CN associated with the beat the left-hand note is to be played on. Accordingly, in FIG. 2, Y1 is to be played on beat two (C2), Y2 is to be played on beat three (C3), and Y3 is to be played on beat four (C4). In some embodiments, a single LH 220 is shown for the entire musical notation 220. In some embodiments, such as when a left-hand pattern of the plurality of left-hand notes changes throughout the music, the musical notation may include two or more LH 220. In such embodiments, the LH 220 may be located above the field of the plurality of fields 210A, 210B, 210C . . . 210N corresponding to the measure the left-hand pattern changes. While in some embodiments LH 220 may be labeled (such as with “LH,” “LH pattern,” or “Left-hand pattern,” in other embodiments, the label may be omitted.

FIGS. 3A-3F are process steps of preparing an example musical notation 300, in accordance with the present technology. Musical notation 300 is also “generic,” that is, it does not represent a specific piece of music but rather shows placeholders for optional elements illustrated in the musical notation 300 disclosed herein.

In FIG. 3A, a plurality of fields 310A, 310B, 310C are provided. In some embodiments, each field of the plurality of fields 310A, 310B, 310C represents a measure of music. In some embodiments, each field of the plurality of fields 310A, 310B, 310C is rectangular or square.

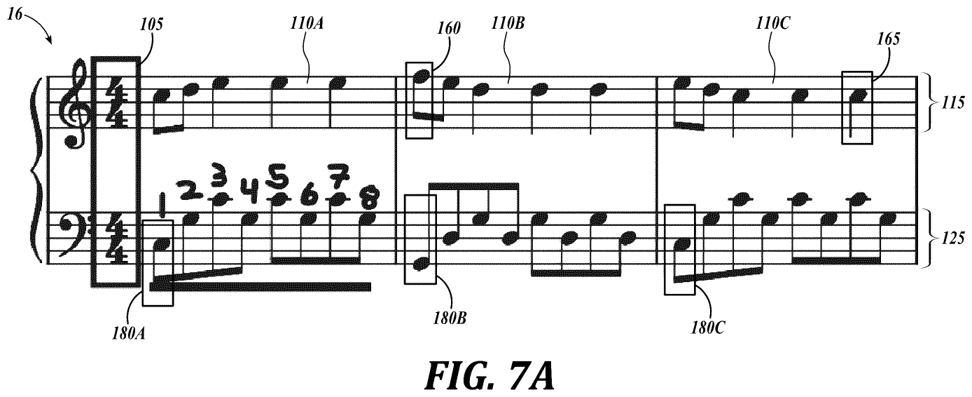

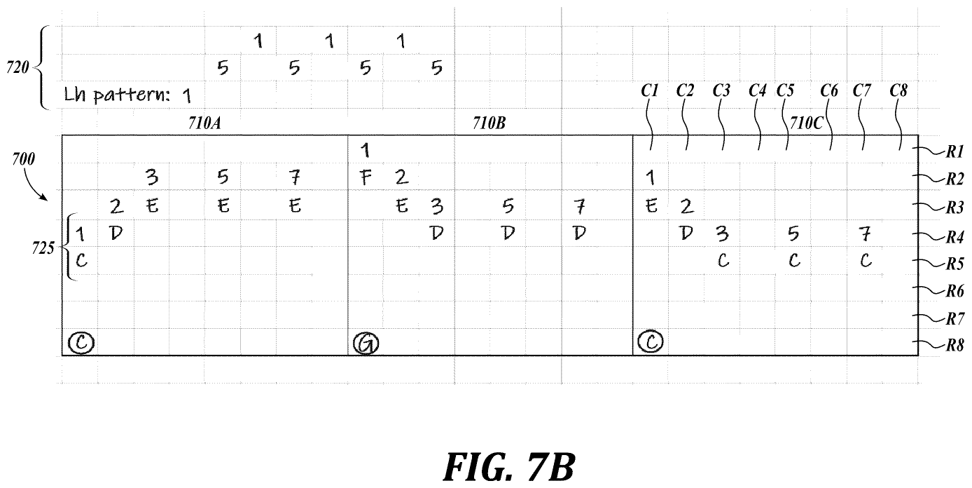

In FIG. 3B, each field of the plurality of fields 310A, 310B, 310C is split into a plurality of columns C1, C2, C3, C4, C5, C6. In some embodiments, each column of the plurality of columns C1, C2, C3, C4, C5, C6 represents a number of beats per measure of music. For example, six columns are shown in musical notation 300. Accordingly, musical notation 300 has six beats per measure. While six columns are illustrated, it should be understood that any number of columns (and thus, beats per measure) may be illustrated, such as 2, 4, 6, 8, 16, or the like. In some embodiments, the number of columns is determined with a time signature (such as time signature 105) of a conventional musical notation (such as conventional musical notation 10). For example, if the time signature of the music is 4/4, the number of columns may be four. In some embodiments, the number of columns is determined by a shortest note in a plurality of right-hand notes (as shown in FIGS. 7A-7B). For example, a time signature of the piece of conventional musical notation may be 4/4, but every note of the plurality of right-hand notes may be an eighth note. In such embodiments, each field of the plurality of fields 310A, 310B, 310C may be split into eight columns.

In FIG. 3B, each field of the plurality of fields 310A, 310B, 310C is split into a plurality of rows R1, R2, R3, R4, R5, R6, R7, R8. In some embodiments, a number of rows in the plurality of rows R1, R2, R3, R4, R5, R6, R7, R8 is determined by a number of distinct pitches in a plurality of right-hand notes. In some embodiments, the musical notation 300 may include a listing of the distinct pitches 330 of the plurality of right-hand notes. In FIG. 3B, there are four distinct pitches X1, X2, X3, X4 in the listing of distinct pitches 330. In some embodiments, a number of rows in the plurality of rows R1, R2, R3, R4, R5, R6, R7, R8 is greater than or equivalent to a number of distinct pitches in a plurality of right-hand notes. In other embodiments, the number of rows R1, R2, R3, R4, R5, R6, R7, R8 is four more than a number of distinct pitches in the plurality of right-hand notes, as shown in FIG. 3C. There are eight rows in FIG. 3C. In some embodiments, a highest distinct pitch X1 is assigned to a second row (R2) of the plurality of rows R1, R2, R3, R4, R5, R6, R7, R8, and a lowest distinct pitch X4 is assigned to a fourth row from a bottom row (R4) of the plurality of rows R1, R2, R3, R4, R5, R6, R7, R8. In some embodiments, the listing of distinct pitches 330 is visible in the musical notation 300. In other embodiments, it is not visible, and the listing of distinct pitches 330 is merely shown for clarity.

In FIG. 3D, a base note B1, B2, B3 of a plurality of left-hand notes in each field of the plurality of fields 310A, 310B, 310C is indicated with a base note indicator 315. Base notes B1, B2, B3 are pitches of the base note for each measure of music. Base notes B1, B2, B3 may be the same pitch (such as shown in FIG. 4G) or different pitches (such as shown in FIGS. 5B, 6B, and 7B) depending on the piece of music the musical notation 300 represents. In some embodiments, the base note indicator 315 is circular. In some embodiments, the base note indicator 315 is located in a bottom left corner of each field of the plurality of fields 310A, 310B, 310C.

In FIG. 3E, each right-hand note 325 of the plurality of right-hand notes (N1, L1; N2, L2; N3, L3; N4, L4; N5, L5) is arranged into a column of the plurality of columns C1, C2, C3, C4, C5, C6, and a row of the plurality of rows R1, R2, R3, R4, R5, R6, R7, R8 based on a beat on which the right-hand note is to be played and a pitch of the right-hand note, respectively, as described herein. In some embodiments, each right-hand note 325 of the plurality of right hand-notes further comprises a color corresponding to the pitch of the right-hand note. In some embodiments, each right-hand note 325 of the plurality of right-hand notes includes a letter L1, L2, L3, L4, L5 representing the pitch of the right-hand note and a number N1, N2, N3, N4, N5 representing the beat the right-hand note is to be played on. In some embodiments, the number N1, N2, N3, N4, N5 is directly above the letter L1, L2, L3, L4, L5, as shown in FIG. 3E.

In FIG. 3F, a left-hand pattern (“LH”) 320 is provided. In some embodiments, the LH 220 includes a series of numbers Y1, Y2, Y3 as explained herein, where each number of the series of numbers corresponds to a scale degree of each left hand-note of the plurality of left-hand notes, relative to the base note. A vertical and/or horizontal position of each number in the series of numbers Y1, Y2, Y3 may be determined by a value of each number in the series of numbers Y1, Y2, Y3 and a beat which the left-hand note is to be played on, respectively.

As previously explained, FIG. 2 and FIGS. 3A-3F shows generic musical notation according to the present technology. Example musical notation representing the pieces of music of FIGS. 1, 5A, 6A, and 7A are shown in FIGS. 4G, 5B, 6B, and 7B, respectively.

FIGS. 4A-4G are process steps of preparing example musical notation based on the conventional musical notation of FIG. 1, in accordance with the present technology. Accordingly, FIGS. 4A-4G illustrate the process of converting the conventional musical notation 10 of FIG. 1 into the novel musical notation 400 disclosed herein.

In FIG. 4A, four fields 410A, 410B, 410C, and 410D are provided, representing the four measures 110A, 110B, 110C, and 110D of conventional musical notation 10. Each field 410A, 410B, 410C, 410D (collectively, “plurality of fields 410A, 410B, 410C, 410D”) is split into three columns C1, C2, C3 (collectively, “plurality of columns C1, C2, C3, C4”), representing the three beats per measure of conventional musical notation 10. Further, each field of the plurality of fields 410A, 410B, 410C, 410D includes a base note indicator 415.

In FIG. 4B, a highest distinct pitch 160 of a plurality of right-hand notes 115 is identified. In FIG. 4B, the highest distinct pitch 160 is “D”. Similarly, a lowest distinct pitch 165 is also identified. In FIG. 4B, the lowest distinct pitch 165 is “B.” Further, all pitches of the plurality of right-hand notes 115 may be identified (175) to determine a number of distinct pitches of the plurality of right-hand notes 115. A beat that each right-hand note of the plurality of right-hand notes 115 is to be played on may also be identified for each right-hand note of the plurality of right-hand notes (170).

In FIG. 4C, each field of the plurality of fields 410A, 410B, 410C, 410D may be split into a plurality of rows R1, R2, R3, R4, R5, R6, R7. In some embodiments, the number of rows in the plurality of rows R1, R2, R3, R4, R5, R6, R7 is determined by the number of distinct pitches in the plurality of right-hand notes. In some embodiments, the number of rows in the plurality of rows R1, R2, R3, R4, R5, R6, R7 is four more than the number of distinct pitches in the plurality of right-hand notes. Here, there are three distinct pitches (D, C, B). Accordingly, there are seven rows in the plurality of rows R1, R2, R3, R4, R5, R6, R7. As shown in FIG. 4C, a highest distinct pitch 460 may be assigned to a higher column than a lower distinct pitch. In some embodiments, the highest 460 distinct pitch is assigned to a second row (R2) of the plurality of rows R1, R2, R3, R4, R5, R6, R7, and a lowest distinct pitch 465 is assigned to a fourth row (R4) from a bottom row (R7) of the plurality of rows R1, R2, R3, R4, R5, R6, R7.

In FIG. 4D, each right-hand note of the plurality of right-hand notes 115 is represented as a number and a letter (1, B; 2, C; 3, D; 1, C; 2, B; 1, B; 1, D; 2, C; and 3,B). The number corresponds to the beat the right-hand note is to be played on and the letter corresponds to the pitch of the right-hand note. Accordingly, right-hand note 425 is a “B” played on the first beat of the third measure.

In FIG. 4E, a left-hand pattern of the plurality of left-hand notes 125 is identified. Further, a base note 180 of each measure is also identified. The base note 180 represents a lowest pitch of the plurality of left-hand notes 125. Often, the base note 180 is the first note of each measure of music, but not always. In FIG. 4E, the base note 180 of each measure is G, as indicated by the boxes.

In FIG. 4F, each left-hand note is assigned a scale degree of a plurality of scale degrees 195 based on its respective pitch of a plurality of pitches 190, relative to the base note. As the base note is G, it is assigned a number “1.” Accordingly, each pitch in the scale is assigned to a scale degree relative to G. For example, B has a scale degree of “2,” and F has a scale degree of “7.” A full scale, that is 1-7, with the octave 1 is illustrated in FIG. 4F. In some embodiments, both the base note and a note an octave above the base note is assigned the number “1” in the final left-hand pattern (as shown in FIG. 4F). However, as shown in FIG. 7B, the note that is an octave above the base note is represented as a 1 that is placed higher than the base note (and higher than the note having a scale level of “5”). In this way, the octave can be represented without using a separate notation.

In FIG. 4E, a left-hand pattern (“LH Pattern”) 420 is provided based on the scale degree of each left-hand note of the plurality of left-hand notes. As shown in FIG. 4E, each measure had the same left-hand notes as each other. This is not always the case (as shown and described in FIGS. 5B, 6B, and 7B). Accordingly, the base note indicator 415 of each field of the plurality of fields 410A, 410B, 410C, 410D is “G.” Further, the LH pattern 420 only shows a single measure of left-hand notes as a series of numbers 1, 3, 5. This is because each measure of the music has the same scale degrees between each of the left-hand notes. In some embodiments, this may be the case even if the base note changes between measures (as shown in FIG. 5B). The vertical position of the series of numbers 1, 3, 5 is determined based on a value of each number. For example, “5” is the highest value, and thus is represented the highest. As the value of each number corresponds to a pitch relative to the base note, “5” is also the highest pitch of the LH pattern. The horizontal position of the series of numbers 1, 3, 5, may be determined based on a beat in which each left-hand note is to be played. In some embodiments, this corresponds to the beats per measure represented by the plurality of columns C1, C2, C3. For example, in FIGS. 4E, 1 is played on the first beat, 3 is played on the second beat, and 5 is played on the third beat. Accordingly, 1 is in the first column (C1), 3 is in the second column (C2), and 5 is in the third column (C3). In conventional musical notation 10, the LH pattern 220 is repeated every measure, and thus the LH pattern 220 is the same for every measure of the music. Because of this, only one LH pattern 220 is shown. While LH pattern 220 is shown above field 410B, it should be understood that LH pattern 220 is played alongside each field of the plurality of fields 410A, 410B, 410C, 410D. Thus, even though the series of numbers 1, 3, 5 correspond to columns C1, C2, and C3 in field 410B, it should be understood that the left-hand pattern would also be played in columns C1, C2, C3 in field 410A, 410C, and 410D.

In this manner, conventional musical notation 10 may be converted into musical notation 400. Musical notation 400 may be easier for a beginner piano player to read and understand, as it provides a number of intuitive visual advantages over conventional sheet music 10.

FIG. 5A is an example conventional musical notation 12 having four beats per measure. Conventional music notation 12 includes a time signature 105, a plurality of measures 110A, 110B, 110C, 110D, a plurality of right-hand notes 115, a plurality of left-hand notes 125, a highest right-hand note 160, a lowest right-hand note 165, and a base note 180A, 180B, 180C, 180D for each measure of the plurality of measures 110A, 110B, 110C, 110D.

FIG. 5B is an example musical notation 500 based on the conventional musical notation 12 of FIG. 5A in accordance with the present technology. The musical notional 500 includes four fields 510A, 510B, 510C, 510D corresponding with the plurality of measures 110A, 110B, 110C, 110D of conventional musical notation 12. Further, each field of the four fields 510A, 510B, 510C, 510D includes four columns C1, C2, C3, C4. This is because conventional musical notation 12 has four beats per measure. Each field of the four fields 510A, 510B, 510C, 510D also includes eleven rows R1, R2, R3, R4, R5, R6, R7, R8, R9, R10, R11. This is because conventional musical notation 12 has seven distinct pitches in the plurality of right-hand notes: A, B, C, D, E, F, and G. While a listing of distinct pitches is not present in FIG. 5B, it should be understood that each of these distinct pitches has still been assigned a row of the eleven rows R1, R2, R3, R4, R5, R6, R7, R8, R9, R10, R11. As shown in FIG. 5B, A, the lowest distinct pitch of the plurality of right-hand notes is assigned to column eight (C8), which is four rows from a bottom row of the eleven rows R1, R2, R3, R4, R5, R6, R7, R8, R9, R10, R11. Similarly, G, the highest distinct pitch of the plurality of right-hand notes has been assigned column two (C2), and so on. Each right-hand note of the plurality of right-hand notes is arranged based on its pitch and the beat on which it is to be played on. Accordingly, right-hand note 525 has the pitch A (represented by the letter “A”) and is played on beat 1 of the first measure (represented by the number “1”).

Further, each field of the four fields 510A, 510B, 510C, 510D includes a base note indicator 515. As shown in FIG. 5A, each measure of the plurality of measures 110A, 110B, 110C, 110D has a base note 180A, 180B, 180C, 180D. In conventional musical notation 12, the base notes are A, G, G, and C, respectively. Accordingly, the base note indicators 515 for each field of the four fields 510A, 510B, 510C, 510D indicate base notes of A, G, G, and C, respectively.

Additionally, the left-hand pattern (“LH pattern”) 520 is shown at the top of musical notation 500. As the LH pattern 520 is the same for every field of the four fields 510A, 510B, 510C, 510D only LH pattern 520 is shown. As shown in FIG. 5B, the LH pattern 520 includes left-hand notes having scale degrees of 1, 3, 5, and 3, relative to the pitch shown in the base note indicator 515 of each field of the four fields 510A, 510B, 510C, 510D. In this way, the plurality of left-hand notes 125 in the conventional musical notation 12 are all represented by LH pattern 520.

Accordingly, musical notation 500 is a complete visual representation of conventional musical notation 12.

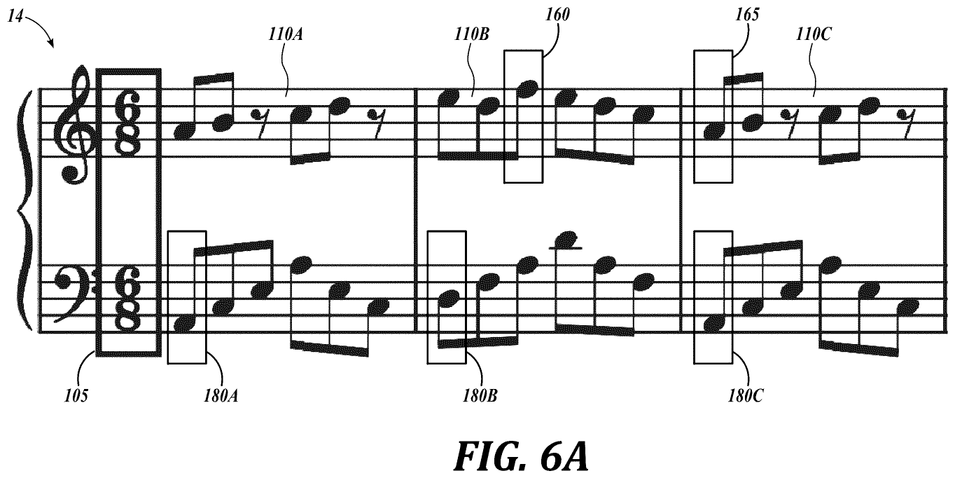

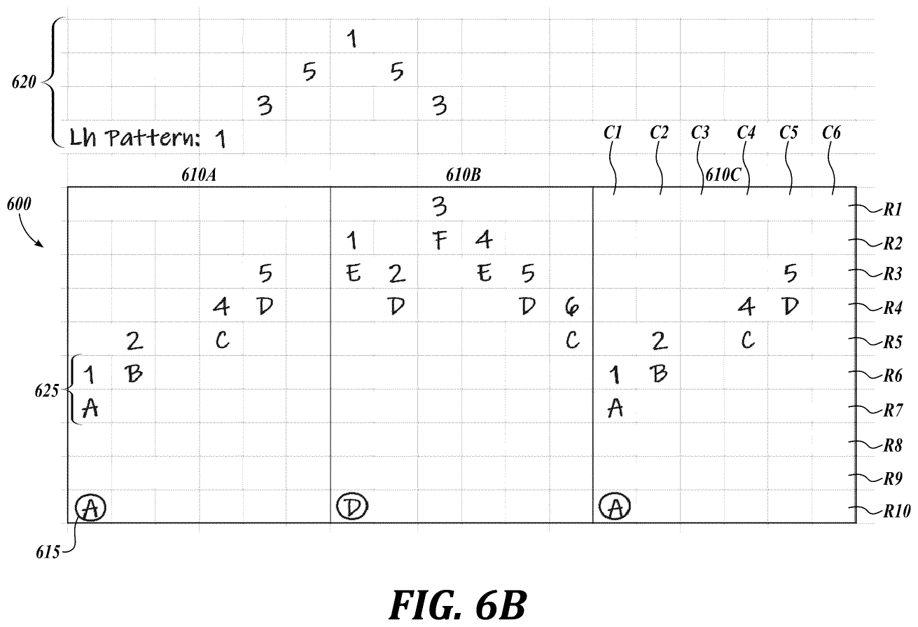

FIG. 6A is another example conventional musical notation 14 having six beats per measure. Conventional music notation 14 includes a time signature 105, a plurality of measures 110A, 110B, 110C a plurality of right-hand notes 115, a plurality of left-hand notes 125, a highest right-hand note 160, a lowest right-hand note 165, and a base note 180A, 180B, 180C for each measure of the plurality of measures 110A, 110B, 110C.

FIG. 6B is an example musical notation based on the conventional musical notation 14 of FIG. 6A in accordance with the present technology. The musical notional 600 includes three fields 610A, 610B, 610C corresponding with the plurality of measures 110A, 110B, 110C of conventional musical notation 14. Further, each field of the three fields 610A, 610B, 610C includes six columns C1, C2, C3, C4, C5, C6. This is because conventional musical notation 14 has six beats per measure. Each field of the three fields 610A, 610B, 610C also includes ten rows R1, R2, R3, R4, R5, R6, R7, R8, R9, R10. This is because conventional musical notation 14 has six distinct pitches in the plurality of right-hand notes: A, B, C, D, E, and F. While a listing of distinct pitches is not present in FIG. 6B, it should be understood that each of these distinct pitches has still been assigned a row of the ten rows R1, R2, R3, R4, R5, R6, R7, R8, R9, R10. As shown in FIG. 6B, A, the lowest distinct pitch of the plurality of right-hand notes is assigned to column seven (C7), which is four rows from a bottom row of the ten rows R1, R2, R3, R4, R5, R6, R7, R8, R9, R10. Similarly, F, the highest distinct pitch of the plurality of right-hand notes has been assigned column two (C2), and so on. Each right-hand note of the plurality of right-hand notes is arranged based on its pitch and the beat on which it is to be played on. Accordingly, right-hand note 525 has the pitch A (represented by the letter “A”) and is played on beat 1 of the first measure (represented by the number “1”).

Further, each field of the three fields 610A, 610B, 610C includes a base note indicator 615. As shown in FIG. 6A, each measure of the plurality of measures 110A, 110B, 110C has a base note 180A, 180B, 180C. In conventional musical notation 14, the base notes are A, D, A, respectively. Accordingly, the base note indicators 615 for each field of the three fields 610A, 610B, 610C indicate base notes of A, D, A, respectively.

Additionally, the left-hand pattern (“LH pattern”) 620 is shown at the top of musical notation 600. As the LH pattern 620 is the same for every field of the three fields 610A, 610B, 610C only one LH pattern 620 is shown. As shown in FIG. 6B, the LH pattern 620 includes left-hand notes having scale degrees of 1, 3, 5, 1, and 3, relative to the pitch shown in the base note indicator 615 of each field of the three fields 610A, 610B, 610C. In this way, the plurality of left-hand notes 125 in the conventional musical notation 14 are all represented by LH pattern 620.

Accordingly, musical notation 600 is a complete visual representation of conventional musical notation 14.

FIG. 7A is an example conventional musical notation 16 having eight beats per measure. Conventional music notation 16 includes a time signature 105, a plurality of measures 110A, 110B, 110C, 110D, a plurality of right-hand notes 115, a plurality of left-hand notes 125, a highest right-hand note 160, a lowest right-hand note 165, and a base note 180A, 180B, 180C for each measure of the plurality of measures 110A, 110B, 110C. Notably, while the time signature for conventional musical notation 16 is 4/4 (i.e., four beats per measure with a quarter note having the beat), the plurality of left-hand notes 125 are all eighth notes. Accordingly, musical notation 16 may be considered to have eight beats per measure (as labeled 1, 2, 3, 4, 5, 6, 7, 8).

FIG. 7B is an example musical notation based on the conventional musical notation 16 of FIG. 7A in accordance with the present technology. The musical notional 700 includes three fields 710A, 710B, 710C corresponding with the plurality of measures 110A, 110B, 110C of conventional musical notation 16. Further, each field of the three fields 710A, 710B, 710C includes eight columns C1, C2, C3, C4, C5, C6, C7, C8. This is because conventional musical notation 16 has eight beats per measure, as explained in FIG. 7A. Each field of the three fields 710A, 710B, 710C also includes eight rows R1, R2, R3, R4, R5, R6, R7, R8. This is because conventional musical notation 16 has four distinct pitches in the plurality of right-hand notes: C, D, E, and F. While a listing of distinct pitches is not present in FIG. 7B, it should be understood that each of these distinct pitches has still been assigned a row of the eight rows R1, R2, R3, R4, R5, R6, R7, R8. As shown in FIG. 7B, C, the lowest distinct pitch of the plurality of right-hand notes is assigned to column seven (C5), which is four rows from a bottom row of the eight rows R1, R2, R3, R4, R5, R6, R7, R8. Similarly, F, the highest distinct pitch of the plurality of right-hand notes has been assigned column two (C2), and so on. Each right-hand note of the plurality of right-hand notes is arranged based on its pitch and the beat on which it is to be played on. Accordingly, right-hand note 525 has the pitch C (represented by the letter “C”) and is played on beat 1 of the first measure (represented by the number “1”).

Further, each field of the three fields 710A, 710B, 710C includes a base note indicator 715. As shown in FIG. 7A, each measure of the plurality of measures 110A, 110B, 110C has a base note 180A, 180B, 180C. In conventional musical notation 16, the base notes are C, G, C, respectively. Accordingly, the base note indicators 715 for each field of the three fields 710A, 710B, 710C indicate base notes of C, G, C, respectively.

Additionally, the left-hand pattern (“LH pattern”) 720 is shown at the top of musical notation 700. As the LH pattern 720 is the same for every field of the three fields 710A, 710B, 710C only one LH pattern 720 is shown. As shown in FIG. 7B, the LH pattern 720 includes left-hand notes having scale degrees of 1, 5, 1, 5, 1, 5, 1, 5, relative to the pitch shown in the base note indicator 715 of each field of the three fields 710A, 710B, 710C. As shown in LH pattern 720, the plurality of left-hand notes includes an entire octave of notes. Accordingly, both the base note and a note an octave above the base note is assigned the number “1” in the LH pattern 720. However, as shown in FIG. 7B, the note that is an octave above the base note is represented as a 1 that is placed higher than the base note (and higher than the note having a scale level of “5”). In this way, the octave can be represented without using a separate notation. In this way, the plurality of left-hand notes 125 in the conventional musical notation 16 are all represented by LH pattern 720.

Accordingly, musical notation 700 is a complete visual representation of conventional musical notation 16.

FIG. 8 is an example method 800 for visually representing music to be played on a piano, in accordance with the present technology. The method 800 is an example of preparing musical notation (such as musical notation 200, 300, 400, 500, 600 or 700). In some embodiments, the method 800 may prepare the musical notation based on conventional music notation (such as conventional musical notation 10, 12, 14, or 16). In some embodiments, the musical notation may be prepared based on a recording, a live performance, or the like. In some embodiments, the conventional musical notation, the recording, live performance, etc., can be analyzed by a computer and/or a computer algorithm for the purposes of visually representing the piece in the musical notation disclosed herein. Further, in some embodiments, the method 800 may be carried out by a processor and/or computing device, such as a desktop computer, laptop, tablet, smart phone, or the like.

In block 805, a number of beats per measure of music is determined. In some embodiments, the number of beats per measure of music may be determined with a time signature (such as time signature 105) of the music. In other embodiments, the number of beats per measure may be determined by ear or with a computer algorithm. In some embodiments, the number of beats per measure may be determined by the shortest left-hand note in a plurality of left-hand notes (as shown and described in FIGS. 7A-7B).

In block 810, a plurality of fields (such as plurality of fields 210A, 210B, 210C . . . 210N; 310A, 310B, 310C; 410A, 410B, 410C, 410D; 510A, 510B, 510C, 510D; 610A, 610B, 610C; and/or 710A, 710B, 710C) is provided based on a number of measures in the music. In some embodiments, the plurality of fields may be drawn (either by hand or digitally). In some embodiments, a computer algorithm may provide the plurality of fields. In some embodiments, the plurality of fields may be displayed, such as on a computer screen, tablet screen, smartphone screen, or the like.

In block 815, each field of the plurality of fields is split into a plurality of columns (such as plurality of columns C1, C2, C3, C4, C5, C6 . . . CN, etc.). In some embodiments, a number of columns in the plurality of columns is determined based on the number of beats per measure determined in block 805. In some embodiments, each field may also be split into a plurality of rows (such as plurality of rows R1, R2, R3, R4, R5, R6 . . . RN). In some embodiments, each row of the plurality of rows corresponds to a distinct pitch in a plurality of right-hand notes, as explained herein. In some embodiments, a number of rows in the plurality of rows is four more than a number of distinct pitches in the plurality of right-hand notes. In some embodiments, the method may proceed to block 905 of method 900 following block 815.

In block 820, each right-hand note of a plurality of right-hand notes (such as plurality of right-hand notes 115) is arranged in a column and a row of the plurality of columns and plurality of rows described herein. In some embodiments, each right-hand note (e.g., right-hand notes 225, 325, 425, 625, and/or 725) includes a number (such as numbers N1, N2, N3, N4, N5) and a letter (such as letters L1, L2, L3, L4, L5). In some embodiments, the number is displayed above the letter, as shown in FIGS. 2, 3E-3F, 4D, 4G, 5B, 6B, and 7B. In some embodiments, the number corresponds to a beat per measure in which the right-hand note is to be played. In such embodiments, the number also corresponds to the column of the plurality of columns associated with that beat. In some embodiments, the letter represents a pitch of the right-hand note. In such embodiments, the pitch may be located in a row associated with the distinct pitch of the plurality of right hand notes, as described herein.

Optionally, in block 825, each left-hand note of the base indicator may be colored based on its pitch (as shown in FIG. 2).

In block 830, the base note of the plurality of left-hand notes is indicated. In some embodiments, this is done with a base note indicator (such as base note indicator 215, 315, 415, 515, 615, and/or 715).

In block 835, a left-hand pattern (such as left-hand pattern 220, 320, 420, 520, 620, and/or 720) is determined. In some embodiments, the left-hand pattern may be determined based on conventional musical notation, as explained herein. In some embodiments, the left-hand pattern may be determined with a computer algorithm. In some embodiments, the method 800 proceeds to block 1005 of method 1000 after block 835.

In block 840, the left-hand pattern is provided. In some embodiments, the left-hand pattern is displayed above the musical notation, as shown in FIGS. 2, 3E-3F, 4D, 4G, 5B, 6B, and 7B. In some embodiments, the left-hand pattern is displayed as a series of numbers (such as series of numbers Y1, Y2, Y3) having a vertical and horizontal placement. In some embodiments, each number of the series of numbers (i.e., Y1) corresponds to a scale degree relative to the base note, as described herein.

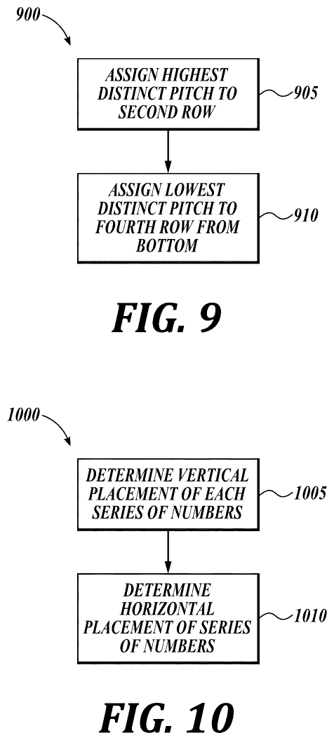

FIG. 9 is another example method 900 for visually representing music to be played on a piano, in accordance with the present technology. The method 900 is an example of preparing musical notation (such as musical notation 200, 300, 400, 500, 600 or 700). In some embodiments, the method 800 may prepare the musical notation based on conventional music notation (such as conventional musical notation 10, 12, 14, or 16). In some embodiments, the musical notation may be prepared based on a recording, a live performance, or the like. In some embodiments, the conventional musical notation, the recording, live performance, etc., can be analyzed by a computer and/or a computer algorithm. Further, in some embodiments, the method 900 may be carried out by a processor in a computer. In some embodiments, method 900 may be carried out as a subset of method 800. In some embodiments, method 900 may be carried out after block 815 of method 800.

In block 905, a highest distinct pitch of the plurality of distinct pitches of the right-hand pattern is assigned to a second row (such as R2) of the plurality of rows.

In block 910, a lowest distinct pitch of the plurality of distinct pitches of the right-hand pattern is assigned to a fourth row from a bottom row of the plurality of rows. In some embodiments, the method 900 proceeds to block 820 of method 800 after block 910.

FIG. 10 is yet another example method 1000 for visually representing music to be played on a piano, in accordance with the present technology. The method 1000 is an example of preparing musical notation (such as musical notation 200, 300, 400, 500, 600 or 700). In some embodiments, the method 1000 may prepare the musical notation based on conventional music notation (such as conventional musical notation 10, 12, 14, or 16). In some embodiments, the musical notation may be prepared based on a recording, a live performance, or the like. In some embodiments, the conventional musical notation, the recording, live performance, etc., can be analyzed by a computer and/or a computer algorithm. Further, in some embodiments, the method 1000 may be carried out by a processor on a computer.

In some embodiments, method 1000 may be carried out as a subset of method 800. In some embodiments, method 1000 may be carried out after block 835 of method 800.

In block 1005, a vertical placement of each number in the series of numbers is determined. In some embodiments, the vertical placement of each number in the series of numbers is determined by the value of the scale degree, as explained in detail in FIG. 4F.

In block 1010, a horizontal placement of each number in the series of numbers is determined. In some embodiments, the horizontal placement of the series of numbers is determined based on the beat the left-hand note represented by the number is to be played on.

In some embodiments, the method 1000 proceeds to block 840 of method 800 after block 1010.

It should be understood that all methods 800, 900, and 1000 should be interpreted as merely representative. In some embodiments, process blocks of all methods 800, 900, and 1000 may be performed simultaneously, sequentially, in a different order, or even omitted, without departing from the scope of this disclosure.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

We claim:

1. A musical notation for piano, comprising:
a plurality of fields, wherein each field of the plurality of fields represents a measure of music, and wherein each field comprises:
a plurality of columns, wherein a number of columns in the plurality of columns is equal to a number of beats per measure,
a plurality of rows, wherein a number of rows in the plurality of rows is greater than or equivalent to a number of distinct pitches in a plurality of right-hand notes, and
a base note indicator comprising a base note of a plurality of left-hand notes; and
a left-hand pattern comprising a series of numbers.

2. The musical notation of claim 1, wherein each field further comprises:
a plurality of right-hand notes, wherein each right-hand note comprises:
a number corresponding to a beat the right-hand note is to be played on; and
a letter corresponding to a pitch of the right-hand note.

3. The musical notation of claim 2, wherein each distinct pitch of the distinct pitches in the plurality of right-hand notes is assigned to a row of the plurality of rows.

4. The musical notation of claim 3, wherein the beat the right-hand note is to be played on determines which column of the plurality of columns the right-hand note is located, and wherein the pitch of the right-hand note determines which row of the plurality of rows the right-hand note is located.

5. The musical notation of claim 1, wherein each number of the series of numbers corresponds to a scale degree of each left hand-note of the plurality of left-hand notes, relative to the base note; or
wherein each number of the series of numbers corresponds to a finger of a left-hand of a player.

6. The musical notation of claim 3, wherein base note indicator includes a color based on a pitch of the base note.

7. The musical notation of claim 1, wherein the number of rows of the plurality of rows is four more than the number of distinct pitches in the plurality of right-hand notes.

8. The musical notation of claim 7, wherein a highest distinct pitch is assigned to a second row of the plurality of rows, and wherein a lowest distinct pitch is assigned to a fourth row from a bottom row of the plurality of rows.

9. The musical notation of claim 1, wherein the musical notation further comprises a listing of the distinct pitches in the plurality of right-hand notes.

10. The musical notation of claim 1, wherein a value of each number of the series of numbers of the left-hand pattern determines a vertical placement of the number on the musical notation.

11. The musical notation of claim 1, wherein the left-hand pattern is located at a top of the musical notation.

12. The musical notation of claim 1, wherein the base note indicator is circular.

13. A method for visually representing music to be played on a piano, comprising:
determining a number of beats per measure of the music;
providing a plurality of fields, wherein each field of the plurality of fields represents a measure of music;
splitting each field of the plurality of fields into a plurality of columns, wherein a number of columns of the plurality of columns is equal to the number of beats per measure;
determining a number of distinct pitches in a plurality of right-hand notes;
splitting each field of the plurality of fields into a plurality of rows, wherein a number of rows of the plurality of rows is at least equal to a number of the distinct pitches in the plurality of right-hand notes;
arranging each right-hand note of the plurality of right-hand notes into a column of the plurality of columns, and a row of the plurality of rows based on a beat on which the right-hand note is to be played and a pitch of the right-hand note, respectively;
indicating a base note of a plurality of left-hand notes in each field of the plurality of fields;
determining a left-hand pattern comprising a series of numbers; and
providing the left-hand pattern on the musical notation.

14. The method of claim 13, wherein each number of the series of numbers corresponds to a scale degree of each left hand-note of the plurality of left-hand notes, relative to the base note; or
wherein each number of the series of numbers corresponds to a finger of a left-hand of a player.

15. The method of claim 14, wherein each right-hand note comprises:
a number corresponding to the beat the right-hand note is to be played on; and
a letter corresponding to the pitch of the right-hand note.

16. The method of claim 14, wherein the number of rows of the plurality of rows is four more than the number of distinct pitches in the plurality of right-hand notes.

17. The method of claim 16, wherein the method further comprises:
assigning a highest distinct pitch to a second row of the plurality of rows; and
assigning a lowest distinct pitch to a fourth row from a bottom row of the plurality of rows.

18. The method of claim 14, wherein the method further comprises:
coloring each base note indicator based on a pitch of the base note.

19. The method of claim 14, wherein providing the left-hand pattern comprises:
determining a vertical placement of each number of the series of numbers based on a value of each number of the series of numbers.

20. The method of claim 19, wherein providing the left-hand pattern comprises:
determining a horizontal placement of each number of the series of numbers based on a beat that each left-hand note of the plurality of left-hand notes is to be played on.
